(19) United States
(12) Patent Application Publication
(10) Pub. No.: US 2017/0094563 A1
(43) Pub. Date: Mar. 30, 2017

(54) CELL TRANSITION THRESHOLD ADJUSTMENT DURING HIGH SPEED RESELECTION OR HANDOVER

(71) Applicant: QUALCOMM Incorporated, San Diego, CA (US)

(72) Inventors: Ming YANG, San Diego, CA (US); Tom CHIN, San Diego, CA (US)

(21) Appl. No.: 14/866,826

(22) Filed: Sep. 25, 2015

(51) Int. Cl. H04W 36/00

(52) U.S. Cl. CPC H04W 36/0005

(57) ABSTRACT

A user equipment (UE) avoids or reduces a “ping pong” scenario when the UE repeatedly transitions between a current serving cell and one or more previous serving cells of a dedicated network in high speed scenarios. In one instance, the UE determines whether a target cell for handover or cell reselection of the UE is one of N previous serving cells, when the UE is in the high speed scenario. The UE also increases a cell reselection threshold and/or measurement reporting threshold for handover or reselection when the target cell is one of the N previous serving cells. The UE can also adjust a measurement frequency of the previous N serving cells when in a high speed state. New neighbor cells will not have their threshold or measurement frequency adjusted.

### BACKGROUND

Field

Aspects of the present disclosure relate generally to wireless communication systems, and more particularly, to avoiding or reducing a “ping pong” scenario when a user equipment (UE) repeatedly transitions between a current serving cell and one or more previous serving cells of a dedicated network in high speed scenarios.

Background

Wireless communication networks are widely deployed to provide various communication services, such as telephony, video, data, messaging, broadcasts, and so on. Such networks, which are usually multiple access networks, support communications for multiple users by sharing the available network resources. One example of such a network is the universal terrestrial radio access network (UTRAN). The UTRAN is the radio access network (RAN) defined as a part of the universal mobile telecommunications system (UMTS), a third generation (3G) mobile phone technology supported by the 3rd Generation Partnership Project (3GPP). The UMTS, which is the successor to global system for mobile communications (GSM) technologies, currently supports various air interface standards, such as wideband-code division multiple access (W-CDMA), time division-code division multiple access (TD-CDMA), and time division-synchronous code division multiple access (TD-SCDMA). For example, China employs TD-SCDMA as the underlying air interface in the UTRAN architecture with its existing GSM infrastructure as the core network. The UMTS also supports enhanced 3G data communications protocols, such as high speed packet access (HSPA), which provides higher data transfer speeds and capacity to associated UMTS networks. HSPA is a collection of two mobile telephony protocols, high speed downlink packet access (HSDPA) and high speed uplink packet access (HSUPA) that extends and improves the performance of existing wideband protocols.

As the demand for mobile broadband access continues to increase, research and development continue to advance the UMTS technologies not only to meet the growing demand for mobile broadband access, but also to advance and enhance the user experience with mobile communications.

### SUMMARY

According to one aspect of the present disclosure, a method of wireless communication includes determining whether a target cell for handover or cell reselection of a UE (user equipment) is one of N previous serving cells, when the UE is in a high speed state. The method also includes increasing a cell reselection threshold and/or measurement reporting threshold for handover or reselection when the target cell is one of the N previous serving cells.

According to another aspect of the present disclosure, an apparatus for wireless communication includes means for determining whether a target cell for handover or cell reselection of a UE (user equipment) is one of N previous serving cells, when the UE is in a high speed state. The apparatus may also include means for increasing a cell reselection threshold and/or measurement reporting threshold for handover or reselection when the target cell is one of the N previous serving cells.

Another aspect discloses an apparatus for wireless communication and includes a memory and a transceiver configured for wireless communication. At least one processor is coupled to the memory. The processor(s) is configured to determine whether a target cell for handover or cell reselection of a UE (user equipment) is one of N previous serving cells, when the UE is in a high speed state. The processor(s) is also configured to increase a cell reselection threshold and/or measurement reporting threshold for handover or reselection when the target cell is one of the N previous serving cells.

Yet another aspect discloses a non-transitory computer-readable medium having non-transitory program code recorded thereon which, when executed by the processor(s), causes the processor(s) to determine whether a target cell for handover or cell reselection of a UE (user equipment) is one of N previous serving cells, when the UE is in a high speed state. The program code also causes the processor(s) to increase a cell reselection threshold and/or measurement reporting threshold for handover or reselection when the target cell is one of the N previous serving cells.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a diagram illustrating an example of a network architecture.

FIG. 2 is a diagram illustrating an example of a downlink frame structure in long term evolution (LTE).

FIG. 3 is a diagram illustrating an example of an uplink frame structure in LTE.

FIG. 4 is a block diagram illustrating an example of a global system for mobile communications (GSM) frame structure.

FIG. 5 is a block diagram conceptually illustrating an example of a base station in communication with a user equipment (UE) in a telecommunications system.

FIG. 6 is a diagram illustrating network coverage areas according to aspects of the present disclosure.

FIG. 7 illustrates an example of a network coverage of a dedicated wireless network.

FIG. 8 is a flow diagram of a method for adjusting a target cell threshold, a measurement threshold and a reselection/handover timer according to aspects of the present disclosure.

FIG. 9 is a flow diagram illustrating a method for adjusting transition thresholds according to one aspect of the present disclosure.

FIG. 10 is a diagram illustrating an example of a hardware implementation for an apparatus employing a processing system according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

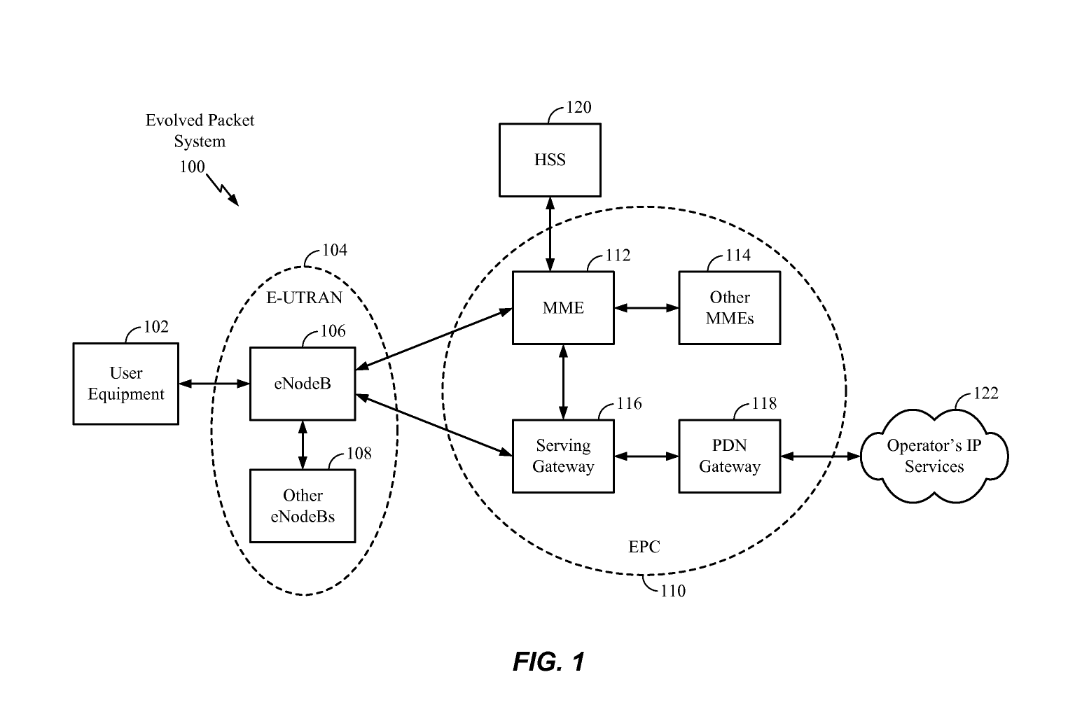

FIG. 1 is a diagram illustrating a network architecture 100 of a long term evolution (LTE) network. The LTE network architecture 100 may be referred to as an evolved packet system (EPS) 100. The EPS 100 may include one or more user equipment (UE) 102, an evolved UMTS terrestrial radio access network (E-UTRAN) 104, an evolved packet core (EPC) 110, a home subscriber server (HSS) 120, and an operator's IP services 122. The EPS can interconnect with other access networks, but for simplicity, those entities/interfaces are not shown. As shown, the EPS 100 provides packet-switched services, however, as those skilled in the art will readily appreciate, the various concepts presented throughout this disclosure may be extended to networks providing circuit-switched services.

The E-UTRAN 104 includes an evolved NodeB (eNodeB) 106 and other eNodeBs 108. The eNodeB 106 provides user and control plane protocol terminations toward the UE 102. The eNodeB 106 may be connected to the other eNodeBs 108 via a backhaul (e.g., an X2 interface). The eNodeB 106 may also be referred to as a base station, a base transceiver station, a radio base station, a radio transceiver, a transceiver function, a basic service set (BSS), an extended service set (ESS), or some other suitable terminology. The eNodeB 106 provides an access point to the EPC 110 for a UE 102. Examples of UEs 102 include a cellular phone, a smart phone, a session initiation protocol (SIP) phone, a laptop, a notebook, a netbook, a smartbook, a personal digital assistant (PDA), a satellite radio, a global positioning system, a multimedia device, a video device, a digital audio player (e.g., MP3 player), a camera, a game console, or any other similar functioning device. The UE 102 may also be referred to by those skilled in the art as a mobile station or apparatus, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNodeB 106 is connected to the EPC 110 via, e.g., an 51 interface. The EPC 110 includes a mobility management entity (MME) 112, other MMEs 114, a serving gateway 116, and a packet data network (PDN) gateway 118. The MME 112 is the control node that processes the signaling between the UE 102 and the EPC 110. Generally, the MME 112 provides bearer and connection management. All user IP packets are transferred through the serving gateway 116, which itself is connected to the PDN gateway 118. The PDN gateway 118 provides UE IP address allocation as well as other functions. The PDN gateway 118 is connected to the operator's IP services 122. The operator's IP services 122 may include the Internet, the Intranet, an IP multimedia subsystem (IMS), and a PS streaming service (PSS).

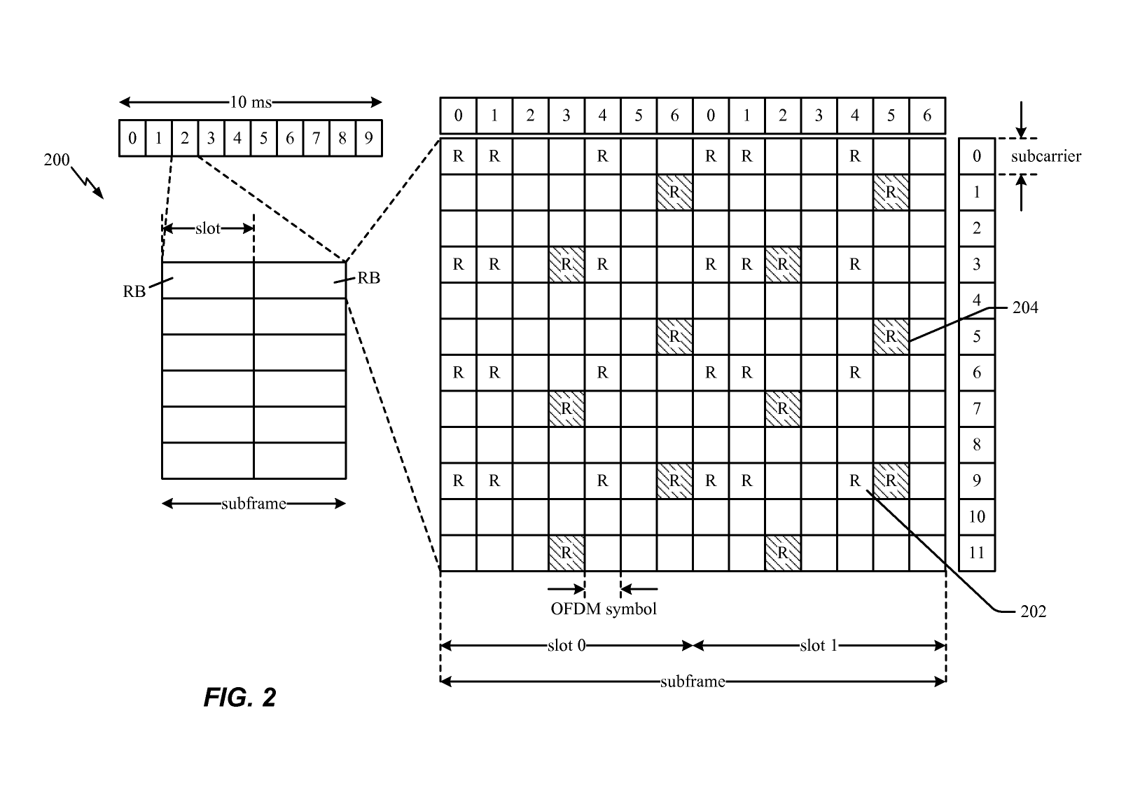

FIG. 2 is a diagram 200 illustrating an example of a downlink frame structure in LTE. A frame (10 ms) may be divided into 10 equally sized sub-frames. Each sub-frame may include two consecutive time slots. A resource grid may be used to represent two time slots, each time slot including a resource block. The resource grid is divided into multiple resource elements. In LTE, a resource block contains 12 consecutive subcarriers in the frequency domain and, for a normal cyclic prefix in each orthogonal frequency division multiplexing (OFDM) symbol, 7 consecutive OFDM symbols in the time domain, or 84 resource elements. For an extended cyclic prefix, a resource block contains 6 consecutive OFDM symbols in the time domain and has 72 resource elements. Some of the resource elements, as indicated as R 202, 204, include downlink reference signals (DL-RS). The DL-RS include Cell-specific RS (CRS) (also sometimes called common RS) 202 and UE-specific RS (UE-RS) 204.

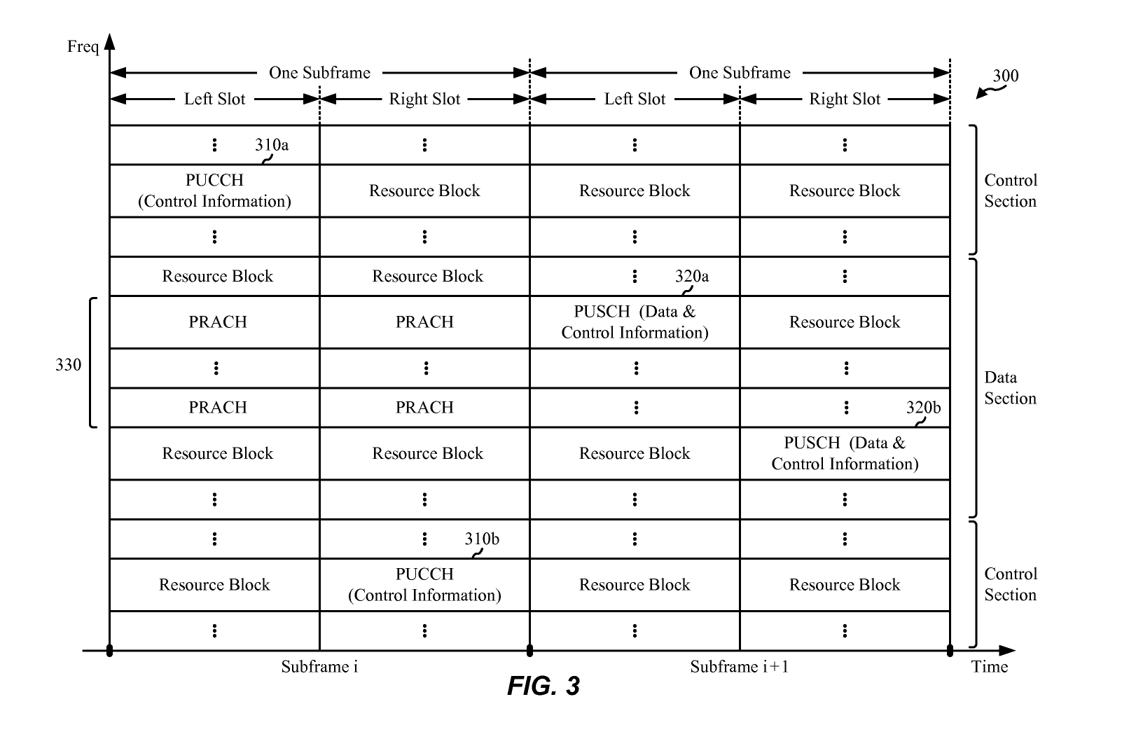

FIG. 3 is a diagram 300 illustrating an example of an uplink frame structure in LTE. The available resource blocks for the uplink may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The uplink frame structure results in the data section including contiguous subcarriers, which may allow a single UE to be assigned all of the contiguous subcarriers in the data section.

A UE may be assigned resource blocks 310a, 310b in the control section to transmit control information to an eNodeB. The UE may also be assigned resource blocks 320a, 320b in the data section to transmit data to the eNodeB. A set of resource blocks may be used to perform initial system access and achieve uplink synchronization in a physical random access channel (PRACH) 330.

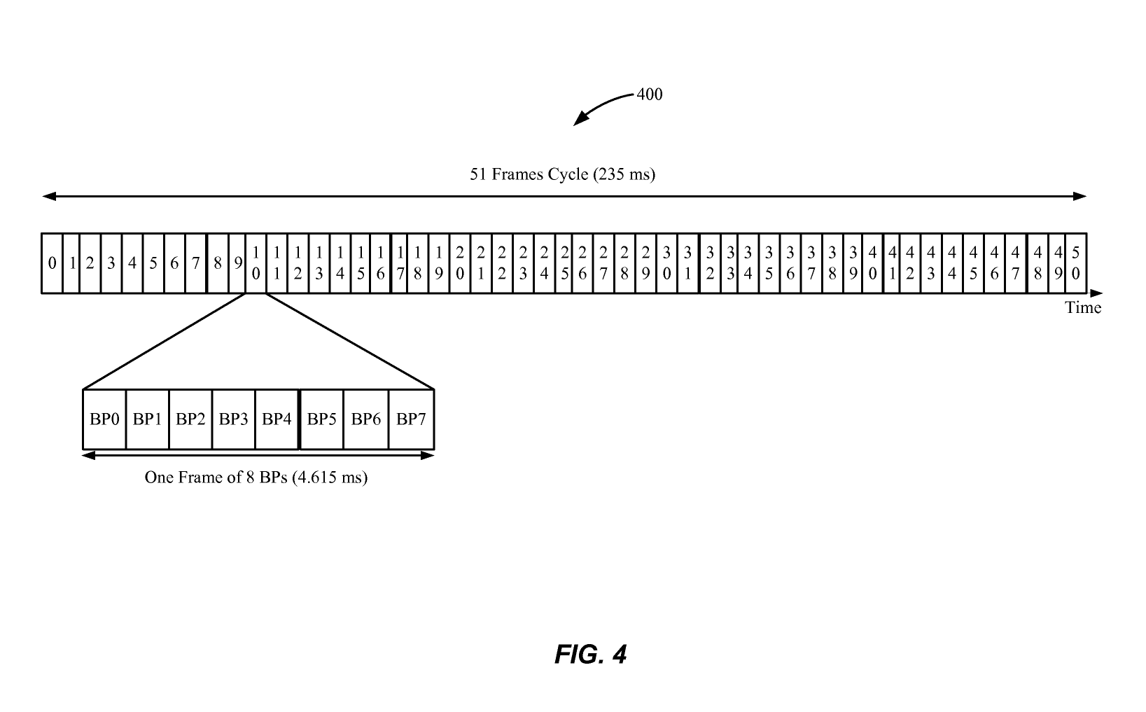

FIG. 4 is a block diagram illustrating an example of a GSM frame structure 400. The GSM frame structure 400 includes fifty-one frame cycles for a total duration of 235 ms. Each frame of the GSM frame structure 400 may have a frame length of 4.615 ms and may include eight burst periods, BP0-BP7.

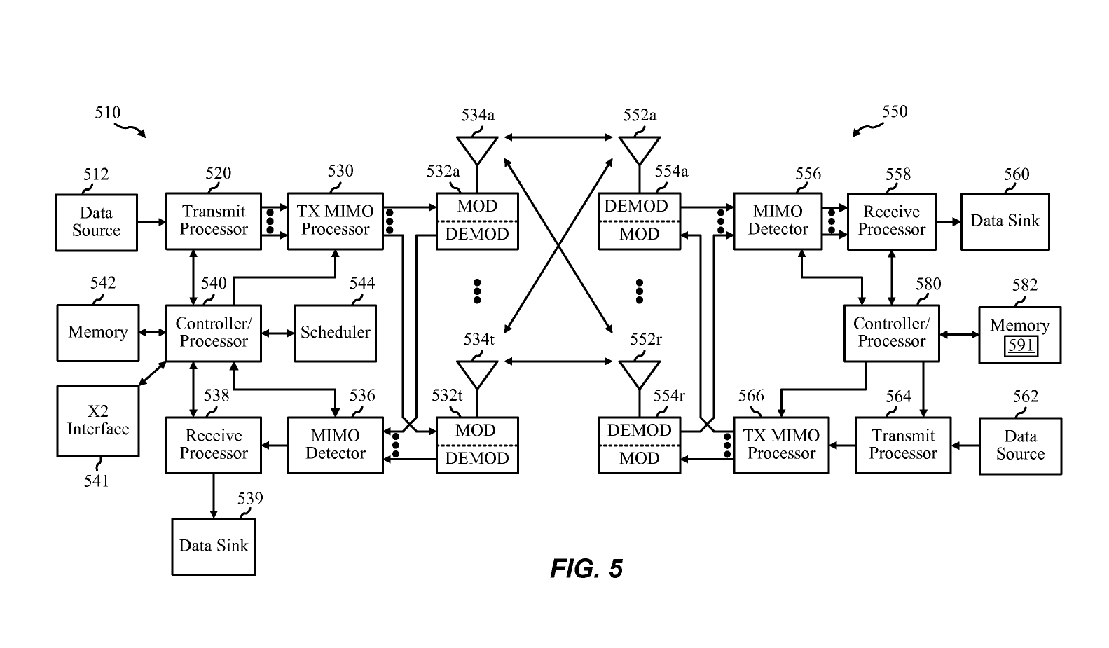

FIG. 5 is a block diagram of a base station (e.g., eNodeB or nodeB) 510 in communication with a UE 550 in an access network. In the downlink, upper layer packets from the core network are provided to a controller/processor 580. The base station 510 may be equipped with antennas 534a through 534t, and the UE 550 may be equipped with antennas 552a through 552r.

At the base station 510, a transmit processor 520 may receive data from a data source 512 and control information from a controller/processor 540. The processor 520 may process (e.g., encode and symbol map) the data and control information to obtain data symbols and control symbols, respectively. The processor 520 may also generate reference symbols. A transmit (TX) multiple-input multiple-output (MIMO) processor 530 may perform spatial processing (e.g., precoding) on the data symbols, the control symbols, and/or the reference symbols, if applicable, and may provide output symbol streams to the modulators (MODs) 532a through 532t. Each modulator 532 may process a respective output symbol stream (e.g., for OFDM, etc.) to obtain an output sample stream. Each modulator 532 may further process (e.g., convert to analog, amplify, filter, and upconvert) the output sample stream to obtain a downlink signal. Downlink signals from modulators 532a through 532t may be transmitted via the antennas 534a through 534t, respectively.

At the UE 550, the antennas 552a through 552r may receive the downlink signals from the base station 510 and may provide received signals to the demodulators (DEMODs) 554a through 554r, respectively. Each demodulator 554 may condition (e.g., filter, amplify, downconvert, and digitize) a respective received signal to obtain input samples. Each demodulator 554 may further process the input samples (e.g., for OFDM, etc.) to obtain received symbols. A MIMO detector 556 may obtain received symbols from all the demodulators 554a through 554r, perform MIMO detection on the received symbols if applicable, and provide detected symbols. A receive processor 558 may process (e.g., demodulate, deinterleave, and decode) the detected symbols, provide decoded data for the UE 550 to a data sink 560, and provide decoded control information to a controller/processor 580.

On the uplink, at the UE 550, a transmit processor 564 may receive and process data (e.g., for the PUSCH) from a data source 562 and control information (e.g., for the PUCCH) from the controller/processor 580. The processor 564 may also generate reference symbols for a reference signal. The symbols from the transmit processor 564 may be precoded by a TX MIMO processor 566 if applicable, further processed by the modulators 554a through 554r (e.g., for single carrier-frequency division multiple access (SC-FDMA), etc.), and transmitted to the base station 510. At the base station 510, the uplink signals from the UE 550 may be received by the antennas 534, processed by the demodulators 532, detected by a MIMO detector 536 if applicable, and further processed by a receive processor 538 to obtain decoded data and control information sent by the UE 550. The processor 538 may provide the decoded data to a data sink 539 and the decoded control information to the controller/processor 540. The base station 510 can send messages to other base stations, for example, over an X2 interface 541.

The controllers/processors 540 and 580 may direct the operation at the base station 510 and the UE 550, respectively. The processor 540/580 and/or other processors and modules at the base station 510/UE 550 may perform or direct the execution of the functional blocks illustrated in FIG. 11, and/or other processes for the techniques described herein. For example, the memory 582 of the UE 550 may store a transition threshold adjustment module 591 which, when executed by the controller/processor 580, configures the UE 550 to configure multiple UEs with inter radio access technology measurement reporting thresholds according to one aspect of the present disclosure. The memories 542 and 582 may store data and program codes for the base station 510 and the UE 550, respectively. A scheduler 544 may schedule UEs for data transmission on the downlink and/or uplink.

In the uplink, the controller/processor 580 provides demultiplexing between transport and logical channels, packet reassembly, deciphering, header decompression, control signal processing to recover upper layer packets from the UE 550. Upper layer packets from the controller/processor 580 may be provided to the core network. The controller/processor 580 is also responsible for error detection using an acknowledgment (ACK) and/or negative acknowledgement (NACK) protocol to support hybrid automatic repeat request (HARQ) operations.

In order to ensure quality of service (QoS) of wireless service in a high speed scenario, such as in a high speed train, some service providers have invested a large amount of financial resources into building dedicated radio access technology (RAT) networks (e.g., dedicated LTE networks) for high speed applications (for example, high speed trains). The dedicated LTE networks use a dedicated LTE frequency as compared with a macro or public LTE network that uses non-dedicated, public LTE frequencies.

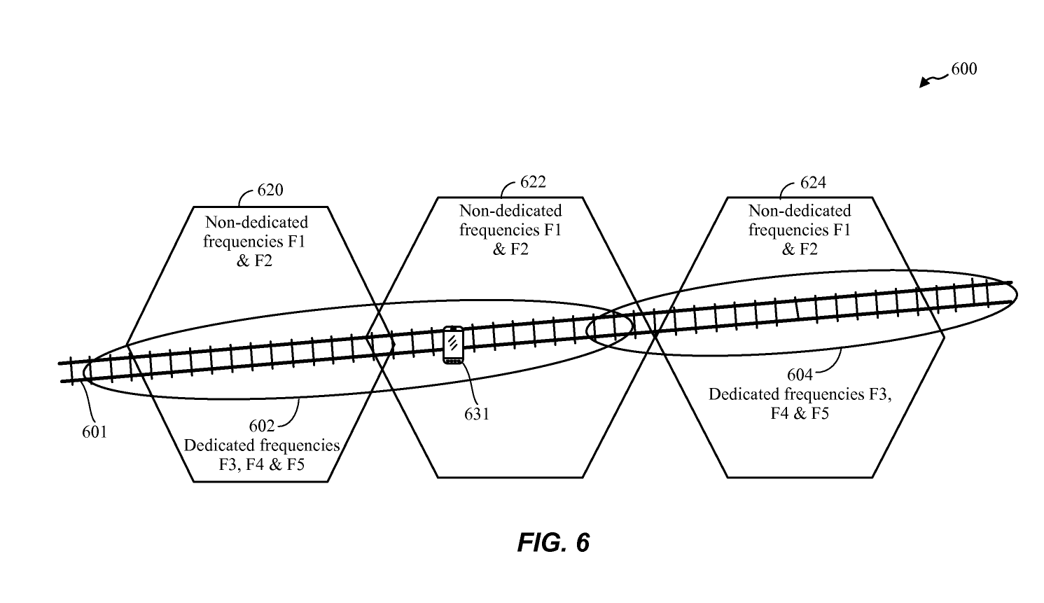

FIG. 6 illustrates a network coverage area example 600 including a dedicated wireless network (dedicated radio access technology (RAT) network) and a non-dedicated, public wireless network. In one example, both the dedicated and non-dedicated wireless networks are LTE or other types of networks, including public and dedicated LTE cells. In the following description, LTE networks will be discussed with respect to a high speed train, although the present disclosure contemplates other types of wireless networks and other types of high speed scenarios.

In the example of FIG. 6, public cells include cells 620, 622 and 624. The dedicated cells include cells 602 and 604. Different LTE frequencies are used for public LTE cells 620, 622 and 624 and dedicated LTE cells 602 and 604. For example, LTE frequencies F1 and F2 may be used for the public LTE cells 620, 622 and 624, as shown in the example 600, and LTE frequencies F3, F4 and F5 are for the dedicated LTE cells 602 and 604.

The dedicated cells 602 and 604 are configured in such a way that they are elongated to focus coverage around the train track 601 to serve UEs on high speed trains, such as the UE 631. In contrast, non-dedicated cells, such as the public cells 620, 622 and 624, are configured to cover a more general area. As a result of the different configurations, a dedicated, elongated cell covers a larger area along the train track 601 than a non-dedicated cell. The elongated configuration of a dedicated cell may be achieved via beam forming of directional antennas of the dedicated cells and other techniques.

Handover or cell reselection may be performed when the UE 631 moves from one dedicated cell to another, such as from the cell 602 to the cell 604. A handover or cell reselection may also be performed when the UE moves from the coverage of one radio access technology (RAT) to the coverage area of another RAT (not shown), when there is a coverage hole or lack of coverage in one network, when there is traffic balancing between a first RAT and a second RAT networks, or when one network does not support a desired service (e.g., circuit switched calls in a circuit switched fall back scenario).

As part of a handover while in a connected mode with a dedicated network (e.g., LTE or TD-LTE) the UE 631 may be specified to perform a measurement of a neighboring cell. For example, the UE 631 may measure the neighbor cell, such as the cell 604, for signal strength, frequency channel, and base station identity code (BSIC), etc.

The UE 631 may send the serving cell, such as the cell 602, a measurement report indicating results of the measurement performed by the UE 631. The serving cell may then trigger a handover of the UE 631 to a new cell based on the measurement report. The measurement may include a serving cell signal strength, such as a received signal code power (RSCP) for a pilot channel (e.g., primary common control physical channel (PCCPCH)). The signal strength is compared to a serving cell threshold. The serving cell threshold can be indicated to the UE through dedicated radio resource control (RRC) signaling from the network. The measurement may also include a neighbor cell received signal strength indicator (RSSI). The neighbor cell signal strength can be compared with a neighbor cell threshold.

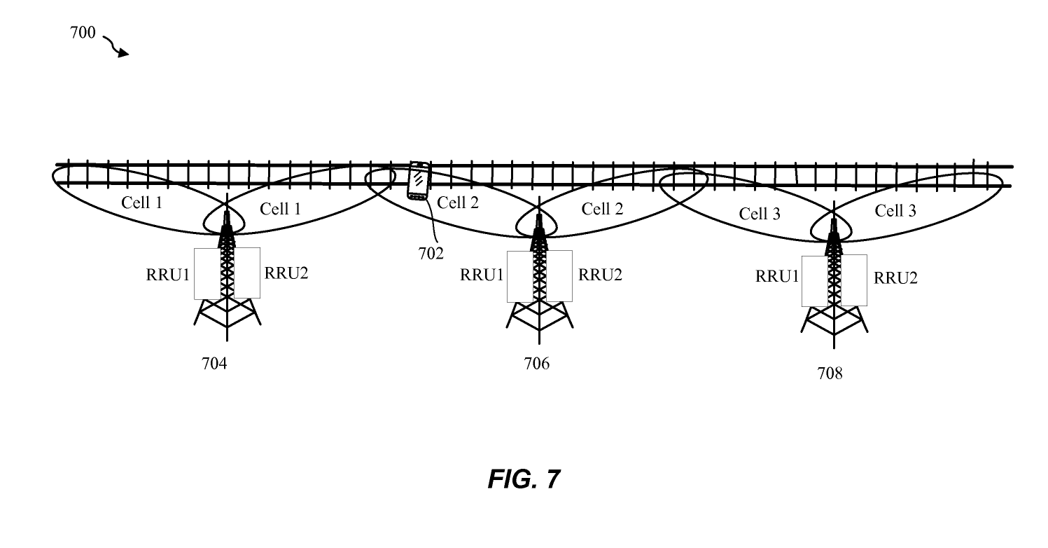

FIG. 7 illustrates an example of a network coverage 700 of a dedicated wireless network. Dedicated networks for high speed scenarios generally deploy one or more single frequency network cells (e.g., cell 1, cell 2 and cell 3). Cell 1, cell 2 and cell 3 are supported by base stations 704, 706 and 708, respectively. Multiple radio resource units (RRUs) such as RRU1 and RRU2 may support a single frequency network cell. For example, one or more of the single frequency network cells may be supported by 2-12 radio resource units and configured according to a line type coverage, as illustrated in FIG. 7. The range for a line type coverage is larger (compared to a circular type coverage) because of its linear coverage. Therefore, the UE 702 can receive signals from multiple cells simultaneously.

Although each single frequency network cell may be specified to cover a predetermined range (e.g., area), the coverage range is not absolute. For example, a single frequency network cell specified to cover a small area (e.g., 50 meters) may actually cover a larger area than specified (e.g., 5 kilometers). As a result, the UE 702 may transition (e.g., reselect or handover) from a current serving cell (e.g., LTE serving cell) to one or more previous serving cells (e.g., previous LTE serving cells) then transition back to the current serving cell. In some instances, (due to the linear coverage) the UE 702 repeatedly transitions between the current serving cell and the one or more previous serving cells causing a “ping pong” scenario. The repeated transition between the current serving cell and the one or more previous serving cells wastes battery power of the UE and degrades throughput.

### Cell Transition Threshold Adjustment During High Speed Reselection or Handover

Aspects of the present disclosure are directed to avoiding or reducing a “ping pong” scenario when a user equipment (UE) repeatedly transitions between a current serving cell and one or more previous serving cells of a dedicated network in high speed scenarios. In one aspect of the disclosure, the UE determines whether a target cell for transitioning (e.g., handover or cell reselection) is one of N previous serving cells, when the user equipment is in a high speed scenario.

The user equipment may determine whether it is in a high speed scenario, based on global positioning system (GPS) measurements or input, a measured average Doppler frequency (or a measured Doppler frequency of a UE), a network indicator and/or a number of cell reselections and handovers within a predefined time window. When the user equipment is in a high speed scenario, the user equipment records a current serving cell and N previous serving cells (e.g., 10 previous serving LTE frequencies) in its memory. For example, the user equipment records the N previous serving cells when the speed of the UE is above threshold (e.g., 300 km/h).

In one aspect of the disclosure, the UE adjusts a cell transition threshold (e.g., cell reselection/handover threshold) when the target cell is one of the N previous serving cells. The UE may adjust the cell reselection/handover threshold by increasing the cell reselection/handover threshold. Among other indications, the cell reselection/handover threshold may be a signal quality threshold of the target cell that indicates when a particular UE should reselect the target cell or be handed over to the target cell or when the handover/reselection procedure starts. For example, the UE reselects the target cell or is handed over to the target cell when the signal quality of the target cell is above a target cell threshold. Accordingly, the UE can reduce the likelihood of or delay the handover or reselection by increasing the target cell threshold. In some aspects, the cell reselection/handover threshold is increased to an extent that effectively prevents handover or reselection. A time to trigger (TTT) timer can also be adjusted for the N previous serving cells, instead of or in addition to the threshold. The timer is not adjusted for the new neighbor cells, which are not one of the N previous serving cells. A handover command may be received from a network instructing handover to at least one previous serving cell. Such a command may be rejected when a serving cell signal quality is above the cell reselection threshold and/or the measurement reporting threshold. A measurement frequency may be reduced or measurement may be stopped of at least one previous serving cell when a serving cell signal quality is above the cell reselection threshold and/or the measurement reporting threshold.

Alternatively or in addition to adjusting the cell reselection/handover threshold, the UE may adjust a cell reselection/handover timer when the target cell is one of the N previous serving cells. The cell reselection/handover timer may also be part of the cell transition threshold. The UE may be handed over, or reselect a cell when the cell reselection/handover timer expires. For example, the UE increases the cell reselection/handover timer to prevent (or increase the difficulty of) the UE from transitioning to the target cell of the N previous serving cells even when a signal quality of the target cell meets a condition for the transition (e.g., greater than the target ell threshold). Thus, the longer the reselection/handover timer the longer the delay for handing over the UE to the target cell or reselecting the target cell.

Alternatively, or in addition to adjusting the target cell threshold and/or the cell reselection/handover timer, the UE may adjust a serving cell threshold when the target cell is one of the N previous serving cells. The serving cell threshold may also be part of the cell transition threshold. Among other indications, the serving cell threshold indicates when a particular UE should reselect the target cell or be handed over to the target cell or when the handover/reselection procedure starts. For example, the UE reselects the target cell or is handed over to the target cell when the signal quality of the serving cell is below the serving cell threshold. In this case, the UE can reduce the likelihood of or delay the handover or reselection by decreasing the serving cell threshold. For example, when the serving cell threshold is reduced, the handover or cell reselection is delayed because it takes a longer period of time for the signal quality of the serving cell to fall below a lower serving cell threshold.

Alternatively or in addition to adjusting the cell transition threshold, the UE may adjust a measurement report timer/threshold when the target cell is one of the N previous serving cells. The measurement report timer/threshold may also be part of the transition threshold. The measurement report indicates results of a measurement performed by the UE. The handover or reselection of the UE to the target cell is based on receiving the measurement report of one or more of the N previous serving cells at the current serving cell. Thus, delaying the measurement report by increasing the measurement report timer ultimately delays or reduces the likelihood of the UE from reselecting or being handed over to one or more of the N previous serving cells. In other aspects, the UE reduces the likelihood of transitioning to one or more of the N previous serving cells by reducing the likelihood of performing measurements for the one or more N previous serving cells.

The value of N may be based on a speed at which the UE is traveling and/or a distance between a current serving cell and each of the N previous serving cells. For example, the value of N is smaller when a distance between a current serving cell (e.g., cell 5) and a previous serving cell (e.g., cell 3) is larger (e.g., 2 km). The value of N, however, is larger when the distance between the current serving cell (e.g., cell 5) and a previous serving cell (e.g., cell 4) is smaller (e.g., 1 km). In some instances, the distance may be an average distance value. In other instances, N is based on a weighted values assigned to each of the N previous serving cells. Further, the value of N may be based on a physical cell identifier (PCI) reuse distance stored in memory of the UE. The physical cell identifier may be based on network identification and radio access technology. For example, the value of N is small when the physical cell identifier reuse distance (e.g., minimal distance for a same cell physical identity reuse) is small. An example range of values for N is 3 to 5, and may vary based on the UE speed and distance between sites.

Further, the adjusting (e.g., increasing) of the cell transition threshold may be based on the speed of the UE and/or a distance between the current serving cell and the N previous serving cells. The UE may update the list of N previous serving cells every time the UE switches from a current serving cell to another serving cell. For example, when the current serving cell is cell 5, the N previous serving cells include cell 3 and cell 4. However, when the current serving cell switches to cell 6, the N previous serving cells include cell 4 and cell 5 (no longer including cell 3). In another example, N can vary. If cell 3 is closer to the serving cell, it may remain on the list, while a further cell would be removed.

In yet another aspect of the disclosure, the adjusting of the cell transition threshold may be based on a call status and/or service type of a call on the UE. For example, when the service type is a file transfer protocol (FTP) download or background data call, the UE increases the cell reselection/handover threshold by a small amount. However, when the service type is voice over internet protocol (VoIP), the UE increases the cell reselection/handover threshold by a large amount. Further, when the call status indicates that a call setup is completed, the UE increases the cell reselection/handover threshold by a small amount. However, when the call status indicates that a call setup is ongoing, the UE increases the cell reselection/handover threshold by a large amount.

In a further aspect of the present disclosure, the adjusting of the cell reselection/handover threshold is based on a signal quality difference between a strongest previous serving cell, which is in the list, and a strongest neighbor cell, which is not in the list of N previous serving cells. For example, when the difference is larger, the UE increases the cell reselection/handover threshold by a small amount. However, when the difference is smaller, the UE increases the cell reselection/handover threshold by a large amount. The adjustments may be on the order of 3 dB, for example.

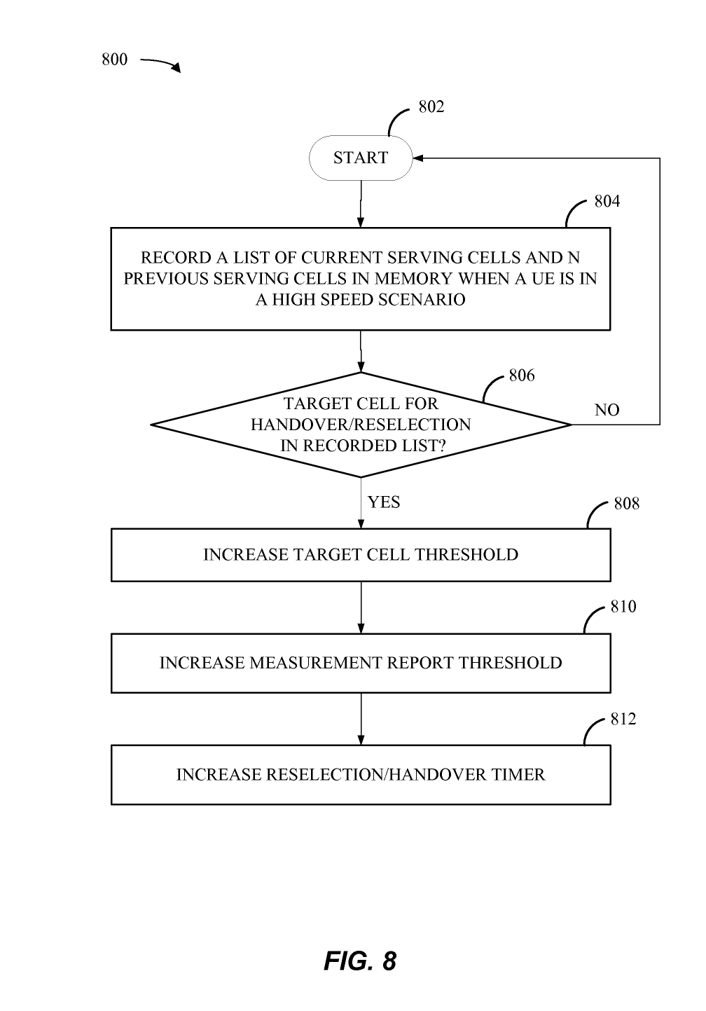

FIG. 8 is a flow diagram 800 of a method for adjusting a target cell threshold, a measurement threshold and a reselection/handover timer according to aspects of the present disclosure. The method avoids or reduces a likelihood of a “ping pong” scenario when a user equipment (UE) repeatedly transitions between a current serving cell and one or more previous serving cells of a dedicated network in high speed scenarios. The method starts at block 802. At block 804, a UE records a current serving cell and N previous serving cells in its memory when the UE is in a high speed scenario. For example, a controller/processor 580 of the UE 550 of FIG. 5 causes the UE 550 to record the current serving cell and N previous serving cells in its memory 582 when the UE is in a high speed scenario. The UE may be in a high speed scenario when the speed of the UE is above a threshold speed. At block 806 the UE determines whether a target cell for handover or cell reselection is one of the N previous serving cells. For example, the controller/processor 580 of the UE 550 causes the UE 550 to determine whether a target cell for handover or cell reselection is one of the N previous serving cells. When the target cell for handover or cell reselection is not one of the N previous serving cells the method returns to block 802 or the UE maintains the target cell threshold, the measurement threshold and the reselection/handover timer. Otherwise, when the target cell for handover or cell reselection is one of the N previous serving cells, the method continues to block 808.

At block 808, the UE adjusts the target cell threshold. For example, the controller/processor 580 of the UE 550 adjusts the target cell threshold. In one aspect of the present disclosure, the UE adjusts the target cell threshold by increasing the target cell threshold to delay or reduce the likelihood of the UE from being handed over to the target cell or reselecting the target cell. In one aspect, the method at block 810 includes the UE adjusting the measurement reporting threshold to further delay or reduce the likelihood of the UE from being handed over to the target cell or reselecting the target cell. For example, the controller/processor 580 of the UE 550 adjusts the measurement reporting threshold. In one aspect, the method at block 812 includes the UE adjusting the reselection/handover timer by increasing the reselection/handover timer. For example, the controller/processor 580 of the UE 550 adjusts the reselection/handover timer. Increasing the reselection/handover timer also delays or reduces the likelihood of the UE from being handed over to the target cell or reselecting the target cell.

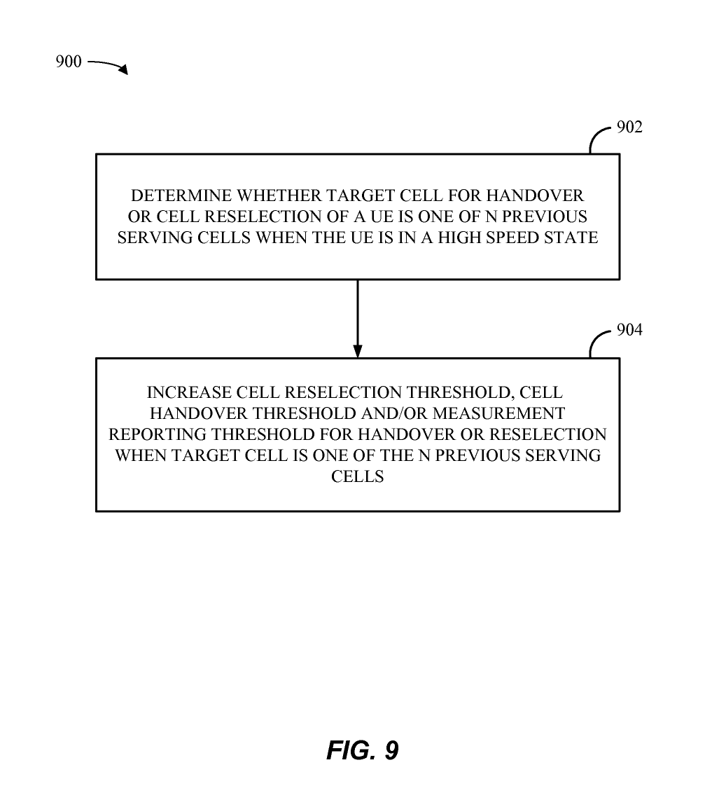

FIG. 9 is a flow diagram illustrating a method 900 for adjusting transition thresholds according to one aspect of the present disclosure. Similar to the method of FIG. 8, the method of FIG. 9 avoids or reduces a likelihood of a “ping pong” scenario when a user equipment (UE) repeatedly transitions between a current serving cell and one or more previous serving cells of a dedicated network in high speed scenarios. In some implementations, the UE reduces or avoids the “ping pong” scenario by first determining, at block 902, whether a target cell for handover or cell reselection of the UE is one of N previous serving cells, when the UE is in a high speed state. For example, the controller/processor 580 of the UE 550 determines whether the target cell for handover or cell reselection of the UE is one of the N previous serving cells. At block 904, the UE increases a cell reselection threshold, cell handover threshold and/or measurement reporting threshold for handover or reselection when the target cell is one of the N previous serving cells. For example, the controller/processor 580 of the UE 550 causes the respective thresholds to be increased.

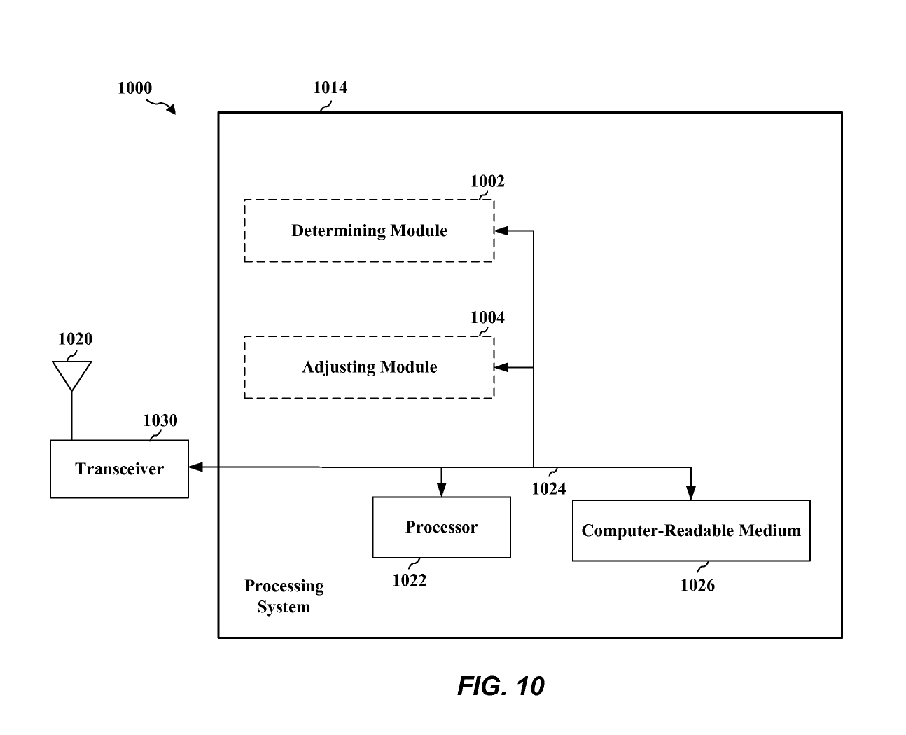

FIG. 10 is a diagram illustrating an example of a hardware implementation for an apparatus 1000 employing a processing system 1014 according to one aspect of the present disclosure. The processing system 1014 may be implemented with a bus architecture, represented generally by the bus 1024. The bus 1024 may include any number of interconnecting buses and bridges depending on the specific application of the processing system 1014 and the overall design constraints. The bus 1024 links together various circuits including one or more processors and/or hardware modules, represented by the processor 1022, a determining module 1002, an adjusting module 1004 and the non-transitory computer-readable medium 1026. The bus 1024 may also link various other circuits such as timing sources, peripherals, voltage regulators, and power management circuits, which are well known in the art, and therefore, will not be described any further.

The apparatus includes a processing system 1014 coupled to a transceiver 1030. The transceiver 1030 is coupled to one or more antennas 1020. The transceiver 1030 enables communicating with various other apparatus over a transmission medium. The processing system 1014 includes a processor 1022 coupled to a non-transitory computer-readable medium 1026. The processor 1022 is responsible for general processing, including the execution of software stored on the computer-readable medium 1026. The software, when executed by the processor 1022, causes the processing system 1014 to perform the various functions described for any particular apparatus. The computer-readable medium 1026 may also be used for storing data that is manipulated by the processor 1022 when executing software.

The processing system 1014 includes a determining module 1002 for determining whether a target cell for handover or cell reselection of a UE (user equipment) is one of N previous serving cells, when the UE is in a high speed state. The processing system also includes an adjusting module 1004 for increasing a cell reselection threshold, cell handover threshold and/or measurement report threshold for handover or reselection when the target cell is one of the N previous serving cells. The determining module 1002 and/or the adjusting module may be software module(s) running in the processor 1022, resident/stored in the computer-readable medium 1026, one or more hardware modules coupled to the processor 1022, or some combination thereof. For example, when the determining module 1002 is a hardware module, the determining module 1002 may include the controller/processor 580. When the adjusting module 1004 is a hardware module, the adjusting module 1004 may include the controller/processor 580. The processing system 1014 may be a component of the UE 550 of FIG. 5 and may include the memory 582, and/or the controller/processor 580.

In one configuration, an apparatus such as a UE 550 is configured for wireless communication including means for determining. In one aspect, the determining means may be the controller/processor 580 of FIG. 5, the memory 582 of FIG. 5, the transition threshold adjustment module 591 of FIG. 5, the determining module 1002 of FIG. 10, the processor 1022 of FIG. 10 and/or the processing system 1014 configured to perform the aforementioned means. In one configuration, the means functions correspond to the aforementioned structures. In another aspect, the aforementioned means may be a module or any apparatus configured to perform the functions recited by the aforementioned means.

In one configuration, an apparatus such as a UE 550 is configured for wireless communication including means for adjusting. In one aspect, the adjusting means may be the controller/processor 580 of FIG. 5, the memory 582 of FIG. 5, the transition threshold adjustment module 591 of FIG. 5, the adjusting module 1004 of FIG. 10, the processor 1022 of FIG. 10 and/or the processing system 1014 configured to perform the aforementioned means. In one configuration, the means functions correspond to the aforementioned structures. In another aspect, the aforementioned means may be a module or any apparatus configured to perform the functions recited by the aforementioned means.

In one configuration, an apparatus such as a UE 550 is configured for wireless communication including means for recording. In one aspect, the recording means may be, for example, the controller/processor 580 of FIG. 5, the memory 582 of FIG. 5, the processor 1022 of FIG. 10 and/or the processing system 1014 configured to perform the aforementioned means. In one configuration, the means functions correspond to the aforementioned structures. In another aspect, the aforementioned means may be a module or any apparatus configured to perform the functions recited by the aforementioned means.

Several aspects of a telecommunications system has been presented with reference to LTE systems. As those skilled in the art will readily appreciate, various aspects described throughout this disclosure may be extended to other telecommunication systems, network architectures and communication standards, including those with high throughput and low latency such as 4G systems, 5G systems and beyond. By way of example, various aspects may be extended to other UMTS systems such as W-CDMA, high speed downlink packet access (HSDPA), high speed uplink packet access (HSUPA), high speed packet access plus (HSPA+) and TD-CDMA. Various aspects may also be extended to systems employing long term evolution (LTE) (in frequency division duplex (FDD), time division duplex (TDD), or both modes), LTE-Advanced (LTE-A) (in FDD, TDD, or both modes), CDMA2000, evolution-data optimized (EV-DO), ultra mobile broadband (UMB), IEEE 802.11 (Wi-Fi), IEEE 802.16 (WiMAX), IEEE 802.20, ultra-wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a non-transitory computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the term “signal quality” is non-limiting. Signal quality is intended to cover any type of signal metric such as received signal code power (RSCP), reference signal received power (RSRP), reference signal received quality (RSRQ), received signal strength indicator (RSSI), signal to noise ratio (SNR), signal to interference plus noise ratio (SINR), etc.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication, comprising:
determining whether a target cell for handover or cell reselection of a UE (user equipment) is one of N previous serving cells, when the UE is in a high speed state; and
increasing a cell reselection threshold and/or a measurement reporting threshold for handover or reselection when the target cell is one of the N previous serving cells.

2. The method of claim 1, in which N is based at least in part on a speed at which the UE is traveling.

3. The method of claim 1, in which N is based at least in part on a distance between a current serving cell and each of the N previous serving cells.

4. The method of claim 1, in which N is based at least in part on a physical cell identifier (PCI) reuse distance stored in memory of the UE based on network identification and radio access technology.

5. The method of claim 1, further comprising recording the N previous serving cells when the UE is in the high speed state.

6. The method of claim 1, further comprising determining whether the UE is in the high speed state based at least in part on a network indicator, a measured Doppler frequency of the UE, and/or global positioning system (GPS) measurements.

7. The method of claim 1, in which an amount of the increasing is based at least in part on a speed of the UE and/or a distance between a current serving cell and the N previous serving cells.

8. The method of claim 1, in which an amount of the increasing is based at least in part on call status and/or service type of communication on the UE.

9. The method of claim 1, in which an amount of the increasing is based at least in part on signal quality difference between a strongest previous serving cell, which is one of the N previous serving cells, and a strongest neighbor cell, which is not one of the N previous serving cells.

10. The method of claim 1, further comprising updating a list of the N previous serving cells every time a UE switches from a current serving cell to another serving cell.

11. The method of claim 1, further comprising rejecting a handover command from a network instructing handover to at least one previous serving cell when a serving cell signal quality is above the cell reselection threshold and/or the measurement reporting threshold.

12. The method of claim 1, further comprising reducing a measurement frequency or stopping measurement of at least one previous serving cell when a serving cell signal quality is above the cell reselection threshold and/or the measurement reporting threshold.

13. The method of claim 1, further comprising increasing a time to trigger for at least one previous serving cell when a serving cell signal quality is above the cell reselection threshold and/or the measurement reporting threshold.

14. An apparatus for wireless communication, comprising:
means for determining whether a target cell for handover or cell reselection of a UE (user equipment) is one of N previous serving cells, when the UE is in a high speed state; and
means for increasing a cell reselection threshold and/or measurement reporting threshold for handover or reselection when the target cell is one of the N previous serving cells.

15. The apparatus of claim 14, in which N is based at least in part on a speed at which the UE is traveling.

16. The apparatus of claim 14, in which N is based at least in part on a distance between a current serving cell and each of the N previous serving cells.

17. The apparatus of claim 14, in which N is based at least in part on a physical cell identifier (PCI) reuse distance stored in memory of the UE based on network identification and radio access technology.

18. The apparatus of claim 14, further comprising means for recording the N previous serving cells when the UE is in the high speed state.

19. An apparatus for wireless communication, comprising:
a memory;
a transceiver configured for wireless communication; and
at least one processor coupled to the memory and the transceiver, the at least one processor configured:
to determine whether a target cell for handover or cell reselection of a UE (user equipment) is one of N previous serving cells, when the UE is in a high speed state; and
to increase a cell reselection threshold and/or measurement reporting threshold for handover or reselection when the target cell is one of the N previous serving cells.

20. The apparatus of claim 19, in which N is based at least in part on a speed at which the UE is traveling.

21. The apparatus of claim 19, in which N is based at least in part on a distance between a current serving cell and each of the N previous serving cells.

22. The apparatus of claim 19, in which N is based at least in part on a physical cell identifier (PCI) reuse distance stored in the memory of the UE based on network identification and radio access technology.

23. The apparatus of claim 19, in which the at least one processor is further configured to record the N previous serving cells when the UE is in the high speed state.

24. The apparatus of claim 19, in which the at least one processor is further configured to determine whether the UE is in the high speed state based at least in part on a network indicator, a measured Doppler frequency of the UE, and/or global positioning system (GPS) measurements.

25. The apparatus of claim 19, in which an amount of the increasing is based at least in part on a speed of the UE and/or a distance between a current serving cell and the N previous serving cells.

26. The apparatus of claim 19, in which an amount of the increasing is based at least in part on call status and/or service type of communication on the UE.

27. The apparatus of claim 19, in which an amount of the increasing is based at least in part on signal quality difference between a strongest previous serving cell and a strongest neighbor cell, which is not one of the N previous serving cells.

28. The apparatus of claim 19, in which the at least one processor is further configured to update a list of the N previous serving cells every time a UE switches from a current serving cell to another serving cell.

29. A non-transitory computer-readable medium having non-transitory program code recorded thereon, the program code comprising:
program code to determine whether a target cell for handover or cell reselection of a UE (user equipment) is one of N previous serving cells, when the UE is in a high speed state; and
program code to increase a cell reselection threshold and/or measurement reporting threshold for handover or reselection when the target cell is one of the N previous serving cells.

30. The computer-readable medium of claim 29, in which N is based at least in part on a speed at which the UE is traveling.
